(19) United States
(12) Patent Application Publication
(10) Pub. No.: US 2025/0226628 A1
(43) Pub. Date: Jul. 10, 2025

(54) POWER ADAPTER

(71) Applicant: ELECOM CO., LTD., Osaka (JP)

(72) Inventor: Shigeru MIYAJIMA, Osaka (JP)

(21) Appl. No.: 19/014,480

(22) Filed: Jan. 9, 2025

(30) Foreign Application Priority Data
Jan. 10, 2024 (JP) 2024-001874

(51) Int. Cl. H01R 31/06; H01R 103/00

(52) U.S. Cl. CPC H01R 31/06; H01R 2103/00

(57) ABSTRACT

A power adapter 10 includes a power plug unit 120, a USB port unit 130, a power outlet unit 140, and a substantially rectangular parallelepiped-shaped enclosure 100 having a front surface 101, a rear surface 102, a top surface 103, a bottom surface 104, a right surface 105, and a left surface 106, wherein the power plug unit 120 is provided on a side of the top surface 103 of the rear surface 102 of the enclosure 100, the enclosure 100 is provided with a stepped part 110 on a side of the bottom surface 104 or the side of the top surface 103 of the front surface 101, and the USB port unit 130 is provided on a side surface 111 that is substantially orthogonal to the front surface 101 of the stepped part 110.

### BACKGROUND OF THE INVENTION

### Field of the Invention

The present invention relates to a power adapter capable of feeding power to a USB device.

### Description of the Related Art

The following power adapters have been proposed as power adapters capable of feeding power to USB devices.

For example, Patent Literature 1 (Japanese Patent Laid-Open No. 2017-16948) proposes a power feeding unit that is capable of feeding power to other electrical devices even in environments where there is only one power outlet and that also enables the use of electronic devices that require USB power feed even in environments where there is no power outlet.

The power feeding unit described in Patent Literature 1 includes a first AC auxiliary power outlet and a second AC auxiliary power outlet electrically connected to a power plug in a lower case of a main body of the power feeding unit in a portion adjacent to the power plug. A power plug to be inserted into an AC power outlet is provided on a side of one end of the lower case. A USB port to function as a power feed port of power to an electronic device such as a speaker for a personal computer is provided on a side of another end of the lower case. Power outputted from the power plug or power outputted from a battery is selectively outputted to the USB port via an electric circuit 15.

Patent Literature 2 (Japanese Patent Laid-Open No. 2014-75349) proposes a partially rotatable power outlet that can expand a range of use of a USB insertion port by providing a rotatable USB power outlet structure.

The power outlet described in Patent Literature 2 includes: a main body which is provided with an insertion port on one surface and a plug on another surface and which includes at least one rotary shaft member; a rotary body which is pivoted to the main body by the rotary shaft member and which rotates horizontally at an arbitrary angle with an X axis being a vertical direction in the main body as an axial center; and at least one USB insertion port which is provided at a Y axis center being a horizontal direction in the rotary body, which rotates in conjunction with the rotary body, and which supplies power to an electronic device.

Patent Literature 3 (Japanese Patent Laid-Open No. 2011-138738) proposes a partially rotatable power outlet that can expand a range of use of a USB insertion port by providing a rotatable USB power outlet structure.

The power outlet described in Patent Literature 3 includes: a main body which includes at least one rotary shaft member; at least one set of insertion ports provided on the main body; a rotary body which is pivoted to the main body by the rotary shaft member and which rotates with the rotary shaft member as an axial center; and at least one USB insertion port which is provided on the rotary body and which rotates in conjunction with the rotary body.

Patent Literature 4 (Japanese Utility Model Registration No. 3141303) proposes a flat tap with a USB power feeding function including a USB insertion port.

The flat tap described in Patent Literature 4 includes: a flat tap casing 1 in which upper and lower casings are joined together; a recess 1a formed in the flat tap casing 1; a plug blade holder 2 rotatably mounted in the recess 1a; a pair of plug blade fittings 3 protruding from the plug blade holder 2; blade receiving fittings 4 electrically connected to the pair of plug blade fittings 3; and blade receiving covers 5 provided on both side surfaces of the flat tap casing 1 orthogonal to the recess 1a and provided with a plug insertion port for inserting a plug into a blade receiving portion 4a of the blade receiving fittings 4, in which a USB substrate 6 electrically connected to the blade receiving fittings 4 is mounted inside the flat tap casing 1 and a USB insertion port 6a is provided on a side surface of the flat tap casing 1 parallel to the recess 1a.

### CITATION LIST

### Patent Literature

Patent Literature 1: Japanese Patent Laid-Open No. 2017-16948
Patent Literature 2: Japanese Patent Laid-Open No. 2014-75349
Patent Literature 3: Japanese Patent Laid-Open No. 2011-138738
Patent Literature 4: Japanese Utility Model Registration No. 3141303

### SUMMARY OF THE INVENTION

Generally, power adapters are connected to AC power outlets provided on walls and the like and are also used to feed power to various USB devices such as mobile phones.

Conventional USB terminals are designed for the purpose of communicating information and bus power that can be fed via USB is limited to low power. Therefore, devices to which power can be fed via USB are limited and each device generally requires its own power adapter. For example, with notebook computers, each manufacturer bundles or sells a dedicated power adapter and users are required to connect the power adapter to an AC power outlet for each device.

However, in recent years, standards such as USB Power-Delivery (PD) have been devised, making it possible to supply power to a variety of devices through USB connections and enabling devices that require large amounts of power such as tablets, main bodies of notebook computers, displays, and projectors in addition to mobile phones to be fed power through USB.

In this case, users no longer need to carry a dedicated power adapter for each device as was conventional and can use a single USB power adapter to use a variety of devices at various locations. In particular, while conventional USB power adapters have been used primarily to charge the batteries of small devices including mobile phones, in the future, USB power adapters will be used more frequently to feed power to operate devices including notebook computers as well as to charge them.

Consequently, for example, while power adapters plugged into an AC power outlet near the floor were often used to charge mobile phones on the floor or by the bedside in the past, in the future, there will be more situations where USB devices are operated at a short distance from power adapters such as when feeding power to a notebook computer or a projector on a desk. In addition, since these USB devices are not stationary devices, USB cables are likely to move when the USB devices are moved slightly, readily causing the power adapters to fall out of the AC power outlet.

In addition, in recent years, although services that provide AC power sources have been increasing in various settings such as cafes and train seats, AC power outlets are not necessarily always provided on vertical wall surfaces due to limitations in space or the like and, for example, AC power outlets may be provided on a rear surface of a desktop or on wall surfaces inclined with respect to the vertical such as a tip portion of a seat handrail. In this case, power adapters will be more prone to the problem of the power adapters readily falling out of the AC power outlets since main bodies of the power adapters will be supported mid-air by power plugs.

In particular, the problem of power adapters readily falling out of AC power outlets becomes more pronounced when power adapters are installed in places subject to vibration such as on trains.

Furthermore, since a USB cable has a retaining portion provided between a connection port and the cable, when the USB cable is connected to a power adapter, the retaining portion protrudes from the power adapter. Therefore, there was a problem that the USB cable was damaged when the user caught this retaining portion. Furthermore, there was a problem that, when trying to install the power adapter in a narrow space, the protruding retaining portion tends to interfere with a floor surface and the like.

In the power feeding unit described in Patent Literature 1, the plug unit (power plug) is configured to be rotatable with respect to the case and the case includes a power plug insertion port (power outlet unit) and a USB port.

However, since the USB port is provided on a surface of the case that is a rectangular parallelepiped and the plug unit and the USB port are respectively arranged on surfaces most separated from one another of the case, there is a problem in that when the USB cable is slightly moved, the case shakes and the plug unit readily falls out of the AC power outlet. In addition, since the retaining portion of the USB cable is to protrude from the case, the user is more likely to catch the USB cable and it becomes more difficult to arrange the power feeding unit in a narrow location.

Furthermore, since the power plug insertion port is rotatable with respect to the case, the case is supposed to be installed along a vertical wall surface, and when installed in an AC power outlet provided on a non-vertical surface such as a slope, there is a problem in that the plug unit more readily falls out.

In the power outlets described in Patent Literature 2 and Patent Literature 3, a USB insertion port (USB port unit) is configured so as to be rotatable with respect to a main body.

However, since a relationship between the plug and the USB insertion port in the main body is not described in Embodiment 1 and the like and the USB insertion port is arranged so as be cross-sectional diagonal of the main body with respect to the plug in Embodiment 4 and the like, there is a problem in that when the USB cable is slightly moved, the case shakes and the plug unit readily falls out of the AC power outlet. In addition, since the retaining portion of the USB cable is to protrude from the case, the user is more likely to catch the USB cable and it becomes more difficult to arrange the power outlet in a narrow location.

Furthermore, while the plug is rotatable with respect to the main body (Embodiment 4), the main body is supposed to be installed along a vertical wall surface, and when installed in an AC power outlet on a non-vertical surface such as a slope, there is a problem in that the main body more readily falls out.

The flat tap with a USB power feeding function described in Patent Literature 4 includes a rotatable plug blade fitting (power plug unit) and a USB insertion port on a flat tap casing.

However, since the USB insertion port is provided on a surface of the flat tap casing that is a rectangular parallelepiped and the plug blade casing and the USB insertion port are respectively arranged on surfaces most separated from one another of the flat tap casing, there is a problem in that when the USB cable is slightly moved, the case shakes and the plug blade fitting unit readily falls out of the AC power outlet. In addition, since the retaining portion of the USB cable is to protrude from the case, the user is more likely to catch the USB cable and it becomes more difficult to arrange the flat tap casing in a narrow location.

Furthermore, while the plug blade fitting is rotatable with respect to the flat tap casing, when the casing is installed in an AC power outlet on a non-vertical surface such as a slope, there is a problem in that the plug blade fitting more readily falls out.

Therefore, an object of the present invention is to provide a power adapter that does not readily fall out of an AC power outlet.

In addition, another object of the present invention is to provide a power adapter that less readily causes a USB cable to be damaged and is readily installed even in a narrow space.

(1)

A power adapter according to one aspect is a power adapter including a power plug unit that can be inserted into an AC power outlet, a USB port unit that can feed power to a USB device, and a substantially rectangular parallelepiped-shaped enclosure having a front surface, a rear surface, a top surface, a bottom surface, a right surface, and a left surface, wherein the power plug unit is provided on a side of the top surface of the rear surface of the enclosure and is rotatably fixed to the enclosure at any angle, the enclosure is provided with a stepped part on the side of the top surface or a side of a bottom surface of the front surface, and the USB port unit is provided on a side surface that is substantially orthogonal to the front surface of the stepped part.

In conventional power adapters, since a USB port unit is provided on a surface of an enclosure (mainly on a bottom surface of a rectangular parallelepiped), a USB cable with elasticity is to pull on the enclosure of the power adapter when a USB device is moved. In this case, since a moment of rotation occurs around the power plug unit inserted into an AC power outlet on a wall or the like and the USB port unit acts as a point of effort, there is a problem in that the power adapter tends to fall out of the AC power outlet even when only affected by a slight force from the USB cable.

In the power adapter according to the one aspect, the power plug unit is provided on the side of the top surface of the rear surface of the enclosure and the USB port unit is provided on the side surface (a surface that is substantially orthogonal to the front surface) of the stepped part that is provided on a side of the bottom surface or the side of the top surface of the front surface of the enclosure. Furthermore, since the power plug unit is inserted into the AC power outlet on the wall or the like and retains the enclosure, compared to a case where the USB port unit is provided on the bottom surface of the enclosure, a distance between the power plug unit and the USB port unit is reduced and an influence of the moment of rotation that the enclosure is subjected to from the USB cable can be suppressed.

Therefore, even when the USB device is moved, since the power plug less readily falls out of the AC power outlet, the power adapter can be prevented from falling out of the AC power outlet.

In addition, since the power adapter is less susceptible to the moment of rotation received from the USB cable and a load on the power plug unit is small, even when the power adapter is installed in an AC power outlet on a non-vertical surface such as a slope or at a location prone to vibration such as inside a train, the power adapter can be prevented from falling out of the AC power outlet.

Furthermore, since the power plug unit is rotatably fixed to the enclosure at any angle, even when the AC power outlet is installed on a front leaning wall (a wall inclined with respect to vertical) surface, the power adapter main body can be supported in midair while maintaining the enclosure of the power adapter in a vertical posture.

In this case, since a center of gravity of the power adapter and the power plug unit supported by the AC power outlet are on a vertical line and the center of gravity of the power adapter does not exert a moment of rotation on the power plug unit, the power adapter can be made more unlikely to fall off from the AC power outlet.

In addition, since the power plug unit is rotatably fixed to the enclosure at any angle, for example, even if the USB port unit is subjected to a moment of rotation by the USB cable, the enclosure rotates while the power plug unit remains inserted in the AC power outlet on the wall surface and, consequently, the power adapter does not fall out of the AC power outlet.

In addition, due to the USB port unit being provided in the stepped part of the enclosure, the retaining portion of the USB cable is stored in the stepped part. Accordingly, a risk of the user catching the retaining portion can be reduced and damage to the USB cable can be prevented.

Furthermore, since the retaining portion of the USB cable is stored in the stepped part, the retaining portion is less likely to interfere with its surroundings including the floor surface and a power adapter that is easy to install even in a narrow space can be provided.

While terms including a front surface as one surface of the enclosure of the power adapter, a rear surface as another surface opposing the front surface, a right surface and a left surface, and a top surface and a bottom surface, as surfaces that are adjacent to the front surface and that oppose each other are used in the present invention for ease of understanding, the front surface need not be on a side of an internal space and the top surface need not be on a side of a vertically upward direction.

(2)

A power adapter according to a second invention is the power adapter according to the invention of one aspect, wherein the stepped part may be provided on the side of the bottom surface of the front surface and may be constructed in a staircase shape with a side surface that is substantially orthogonal to the front surface and a frontal surface that is parallel to the front surface and closer to the rear surface.

The power adapter according to the second invention corresponds to a power adapter according to the first embodiment.

Accordingly, since the stepped part is provided on a diagonal position separated from the power plug unit, inside components (a transformer and the like) of the power adapter can be more readily arranged on the side of the power plug unit and a position of the center of gravity of the power adapter main body can be more readily designed on the side of the power plug unit.

As the moment of rotation exerted on the power adapter, a moment exerted by a weight of the power adapter itself must also be considered in addition to the moment of rotation due to the USB cable described above. In particular, in a space subjected to vibration such as inside a train, designing the power adapter so that the center of gravity of the power adapter main body is located on the side of the power plug unit enables a load applied to the power plug unit to be reduced and prevents the power adapter from falling off from the AC power outlet.

(3)

A power adapter according to a third invention is the power adapter according to the one aspect, wherein the stepped part may be provided on the side of the top surface of the front surface and may be constructed in a staircase shape with a side surface that is substantially orthogonal to the front surface and a frontal surface that is parallel to the front surface and closer to the rear surface.

The power adapter according to the third invention corresponds to a power adapter according to the second embodiment.

In this case, since the power plug unit is provided on the side of the top surface of the rear surface of the enclosure and the USB port unit is also provided on the side of the top surface of the front surface of the enclosure, the distance between the power plug unit and the USB port unit can be minimized. Therefore, since a magnitude of the moment of rotation exerted from the USB cable can be minimized, the power adapter can be prevented from falling off from the AC power outlet.

(4)

A power adapter according to a fourth invention is the power adapter according to any of the one aspect to the third invention, further including a power outlet unit capable of feeding AC power to another device, wherein the power outlet unit may be provided on the front surface of the enclosure.

The presence of the power outlet unit enables power to be fed to another AC device to operate the AC device even when the present power adapter occupies an AC power outlet. Therefore, even when there are not enough AC power outlets such as on trains, power can be fed to a plurality of devices at the same time.

In particular, since the power outlet unit is provided on the front surface of the enclosure and the USB port unit is provided on a stepped side surface, a power cable inserted into the power outlet unit and the USB cable inserted into the USB port unit extend in directions that are mutually orthogonal. Therefore, the power cable and the USB cable are less likely to interfere with each other and the power cable can be readily inserted and extracted.

Furthermore, even if the USB device is moved and a moment of rotation is exerted to the enclosure from the USB cable, since the weight of the power cable connected to the power plug unit acts on the enclosure so as to suppress the moment of rotation, the power adapter can be prevented from falling out of the AC power outlet.

(5)

A power adapter according to a fifth invention is the power adapter according to any of the one aspect to the fourth invention, wherein the power adapter may be configured such that the center of gravity of the power adapter is on a side of the power plug unit relative to a center of the enclosure.

Since the power plug unit is inserted into the AC power outlet to retain the enclosure and the moment of rotation exerted by the weight of the power adapter itself acts around the power plug unit, there is a problem in that the power adapter tends to fall out of the AC power outlet when subjected to vibrations or the like.

Since the center of gravity of the power adapter according to the fifth invention is on the side of the power plug unit relative to the center of the enclosure, a distance between a fulcrum of the moment exerted by the center of gravity and a point of effort is reduced and dropout due to vibrations or the like can be prevented.

Therefore, the power adapter can be made more unlikely to fall out of the AC power outlet even when installed at a location where there is vibration such as on a train or in a car.

(6)

A power adapter according to a sixth invention is the power adapter according to any of the one aspect to the fifth invention, wherein a length N in a longitudinal direction of the enclosure in the stepped part may be 1.5 cm or more.

Accordingly, since the retaining portion of the USB cable is stored inside the stepped part, a risk of the user catching the retaining portion can be reduced and damage to the USB cable can be prevented. In addition, since the retaining portion is less likely to interfere with its surroundings including the floor surface, a power adapter that is easy to install even in a narrow space can be provided.

(7)

A power adapter according to a seventh invention is the power adapter according to any of the one aspect to the sixth invention, wherein the enclosure may include a storage unit that can accommodate the power plug unit, the power plug unit may be axially supported so as to be parallel to an intersecting side of the top surface and the rear surface and may be rotatably fixed to the enclosure at any angle, and a range of angles in which the power plug unit can rotate may be more than 90° and equal to or less than 180°.

Due to the enclosure including the storage unit that can accommodate the power plug unit, the power plug unit can be conveniently stored in the storage unit when carrying the power adapter.

In addition, by setting the angle of the power plug unit during storage to 0° and a range of rotatable angles to more than 90° and equal to or less than 180°, even when a wall surface on which an AC power outlet is installed is a vertical surface, the power adapter can be fixed parallel to the wall surface.

(8)

A power adapter according to an eighth invention is the power adapter according to any of the one aspect to the seventh invention, wherein corners of the right surface and the left surface of the enclosure that axially support the power plug unit each may have a round-shaped cross section, the power plug unit may include a metal plug and a plug base that supports the metal plug, a center of an arc constituting the round shape and a center of rotation of the plug base may coincide with each other, and a radius r of the arc constituting the round shape and a perpendicular distance L from the center of rotation of the plug base to a connecting surface with an opposite power outlet may be a same length.

Accordingly, since the radius r of the arc constituting the round shapes of the enclosure and the perpendicular distance L from the center of rotation of the plug base to the connecting surface are the same, even when the power plug unit is rotated, the connecting surface of the plug base always coincides with a tangent of the round shapes of the enclosure.

Therefore, since corners where the power plug unit is located come into contact with the wall surface where the AC power outlet is provided while the wall surface where the AC outlet is located and the connecting surface of the plug base of the power adapter are in close contact, the metal plug of the power plug unit can be readily inserted fully into the AC power outlet.

In addition, even when a moment of rotation is exerted to the USB port unit by the USB cable, the enclosure can be rotated while the corners of the enclosure remain in contact with the wall surface and the power adapter can be prevented from falling out. Furthermore, even when a moment of rotation in a left-right direction is exerted to the USB port unit, since the corners (round shapes) where the power plug unit is located on the right surface and the left surface are in contact with the wall surface of the AC power outlet, the power adapter is less likely to fall out of the AC power outlet than when only the power plug unit is in contact with the wall surface.

### BRIEF DESCRIPTION OF THE DRAWINGS

FIG. 1 is a schematic perspective view for describing a power adapter according to a first embodiment;

FIG. 2 is a schematic perspective view as viewed from another surface for describing the power adapter according to the first embodiment;

FIG. 3 is a schematic explanatory diagram for describing a power plug unit and round shapes of an enclosure of the power adapter according to the first embodiment;

Each of FIGS. 4A and 4B is a schematic explanatory diagram for describing a movement of the power adapter according to the first embodiment when a force is applied to the power adapter from a USB cable;

Each of FIGS. 5A, 5B, 5C and 5D is a schematic plan view for describing a modification of the first embodiment;

Each of FIGS. 6A and 6B is a schematic plan view for describing another modification of the first embodiment;

Each of FIGS. 7A and 7B is a schematic explanatory diagram for describing a state of use of the power adapter according to the first embodiment; and

FIG. 8 is a schematic perspective view for describing a second embodiment.

### DETAILED DESCRIPTION OF THE INVENTION

### First Embodiment

A power adapter 10 according to a first embodiment can be carried by a user, and by inserting a power plug unit 120 into a household AC power outlet (AC power supply), DC power can be supplied from a USB port unit 130 and power can be fed to USB devices.

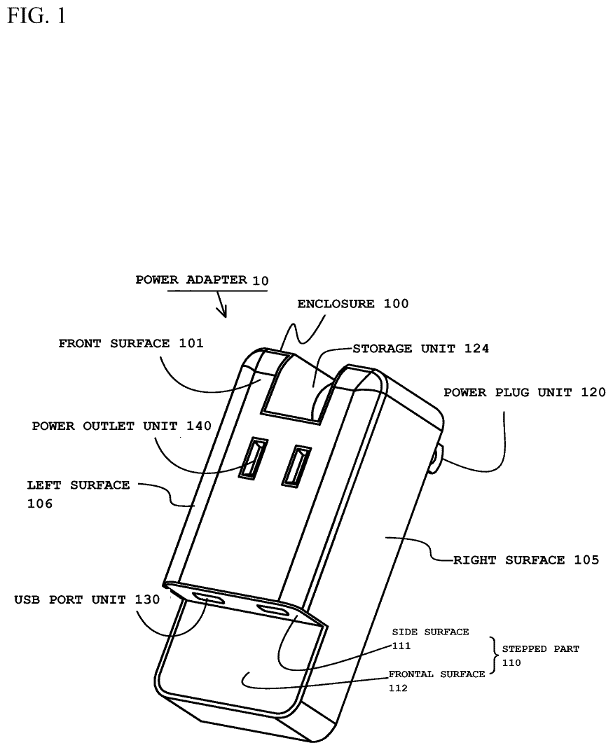

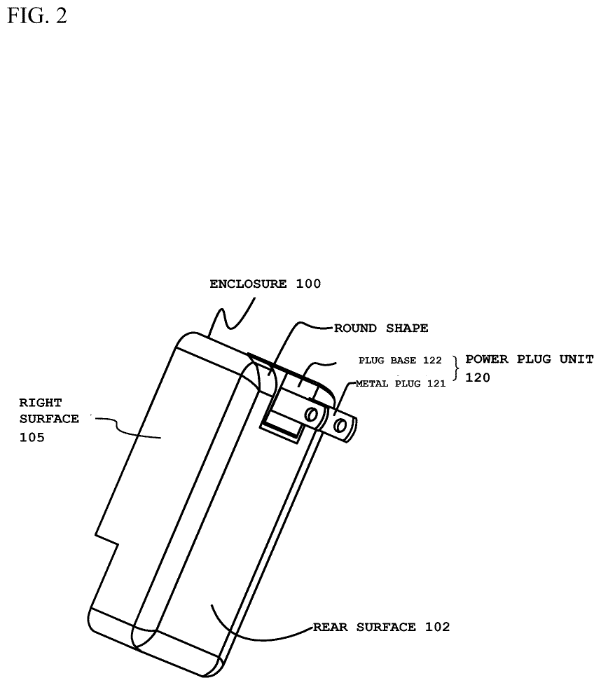

As shown in FIGS. 1 and 2, the power adapter 10 according to the first embodiment includes the power plug unit 120 that can be inserted into an AC power outlet, the USB port unit 130 that can feed power to a USB device, a power outlet unit 140 that can feed AC power to another device, and an enclosure 100 with a substantially rectangular parallelepiped shape having a front surface 101, a rear surface 102, a top surface 103, a bottom surface 104, a right surface 105, and a left surface 106. The power outlet unit 140 is provided on the front surface 101 of the enclosure 100.

In addition, a stepped part 110 is provided on the front surface 101 of the enclosure 100 and the USB port unit 130 is provided on a side surface 111 that is substantially orthogonal to the front surface 101 of the stepped part 110.

The power plug unit 120 has a metal plug 121 that is made of metal and electrically connected to an AC power outlet and a plug base 122 that supports the metal plug 121 and rotatably fixes the metal plug 121 to the enclosure 100. The plug base 122 of the power plug unit 120 is axially supported in a left-right direction of the enclosure 100 and is fixed so as to be rotatable by 180°.

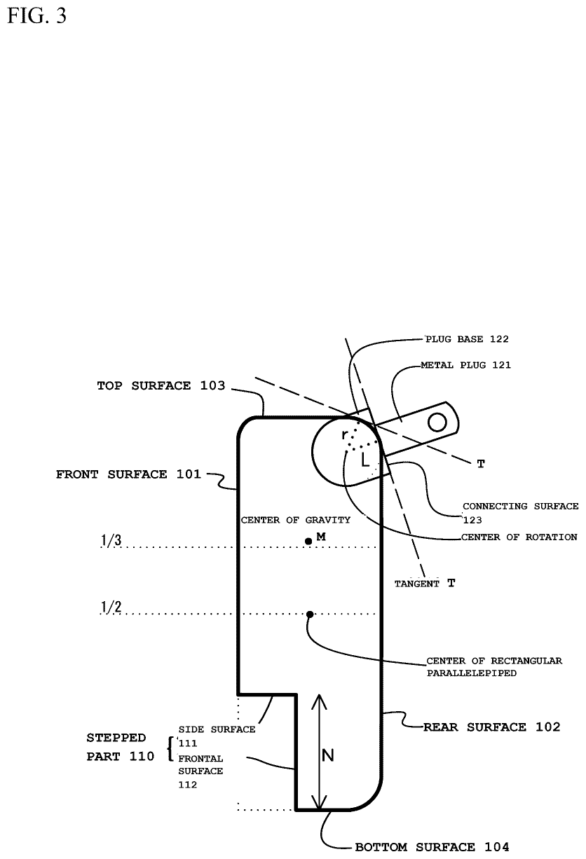

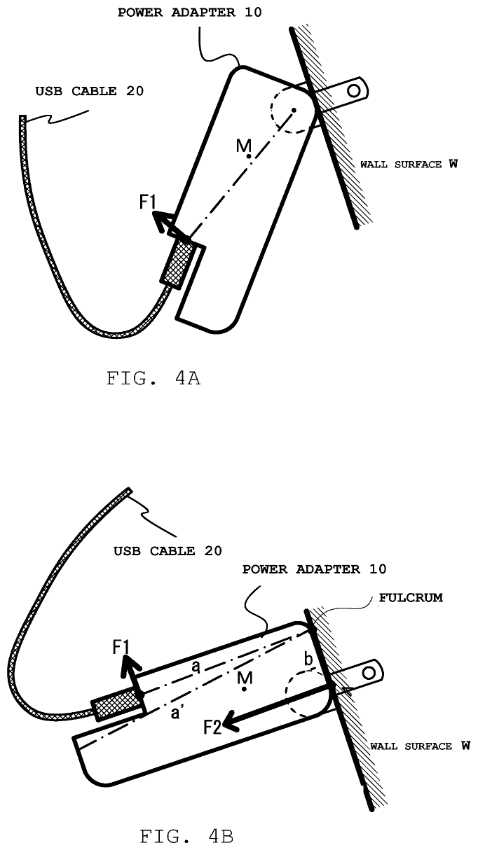

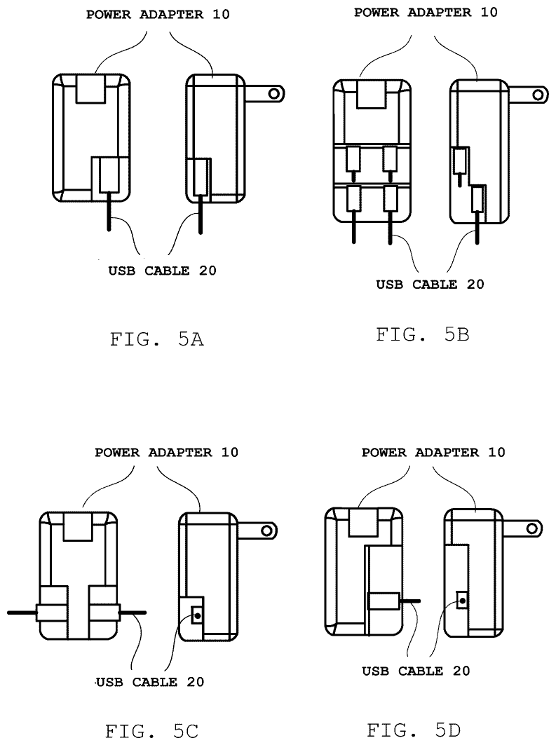

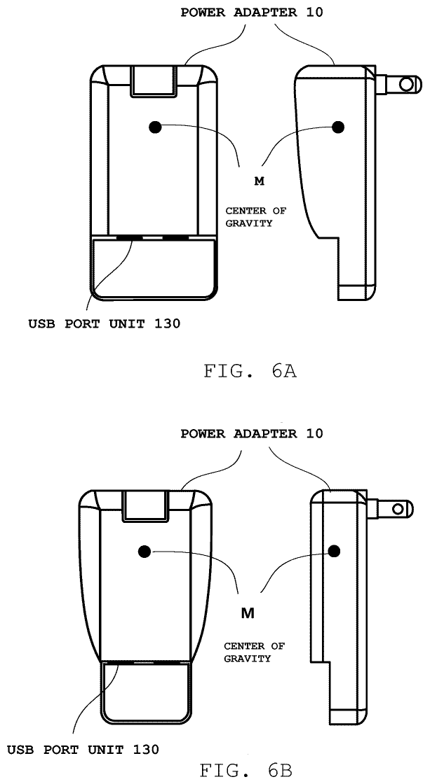

When connecting the power adapter 10 to an AC power outlet provided on a wall surface W, as shown in FIG. 2, the power plug unit 120 is used while being opened at an angle of 180° to be perpendicular to the rear surface 102. On the other hand, as shown in FIG. 3, when connecting the power adapter 10 to an AC power outlet provided on an inclined surface, the power plug unit 120 is used while being opened at an appropriate angle for the inclined surface. In addition, when the power adapter 10 is not in use, the power plug unit 120 can be stored in a storage unit 124 (with an angle of 0°) to facilitate storage or carrying.

### (Stepped Part 110)

The stepped part 110 is provided on a side of the bottom surface 104 of the front surface 101 of the enclosure 100 and is constructed in a staircase shape by the side surface 111 that is substantially orthogonal to the front surface 101 and a frontal surface 112 that is parallel to the front surface 101 and closer to the rear surface 102. The USB port unit 130 is provided on the side surface 111 and power can be fed to a USB device by connecting a USB cable 20 to the USB port unit 130.

As shown in FIG. 3, a length N in a longitudinal direction of the power adapter 10 on the frontal surface 112 of the stepped part 110 is preferably 1.0 cm or more, more preferably 1.5 cm or more, and even more preferably 1.8 cm or more. In addition, the length N is preferably 4.0 cm or less and more preferably 3.0 cm or less.

By making the length equal to or more than the lower limit value described above, since a retaining portion of the USB cable 20 is stored inside the stepped part 110, a risk of the user catching the retaining portion can be reduced and damage to the USB cable 20 can be prevented. In addition, since the retaining portion is less likely to interfere with its surroundings including the floor surface, the power adapter 10 that is easy to install even in a narrow space can be provided. Furthermore, by making the length equal to or less than the upper limit value described above, a size of the enclosure 100 as a whole can be prevented from increasing.

In addition, by providing the USB port unit 130 on the side surface 111 of the stepped part 110 and providing the power outlet unit 140 on the front surface 101 of the enclosure 100, a power cable inserted into the power outlet unit 140 and the USB cable 20 inserted into the USB port unit 130 extend in directions that are mutually orthogonal. Therefore, the power cable and the USB cable 20 are less likely to interfere with each other and the power cable can be readily inserted and extracted.

While an example in which the USB port unit 130 is provided only on the side surface 111 of the stepped part 110 and the power outlet unit 140 is provided only on the front surface 101 of the enclosure 100 is shown in the present embodiment, the USB port unit 130 and the power outlet unit 140 are not limited thereto and the USB port unit 130 and/or the power outlet unit 140 may be appropriately added to any surface such as the right surface 105, the left surface 106, and the front surface 101 of the enclosure 100.

### (Power Plug Unit 120)

FIG. 3 is a schematic explanatory diagram for describing the power plug unit 120 and round shapes of the enclosure 100 of the power adapter 10.

Referring to FIG. 1 and FIG. 3, the enclosure 100 includes a storage unit 124 for storing the power plug unit 120 and the power plug unit 120 includes the plug base 122 and the metal plug 121. The plug base 122 is axially supported so as to be parallel to an intersecting side of the top surface 103 and the rear surface 102 of the enclosure 100.

In addition, corners of the right surface 105 and the left surface 106 of the enclosure 100 that axially support the power plug unit 120 each has a round-shaped cross section, a center of an arc constituting the round shape and a center of rotation of the plug base 122 coincide with each other, and a radius r of the arc constituting the round shape and a perpendicular distance L from the center of rotation of the plug base 122 to a connecting surface 123 with an opposite power outlet are a same length.

According to the configuration described above, even when the power plug unit 120 is rotated, the connecting surface 123 of the plug base 122 is always aligned with a round-shaped tangent of the enclosure 100 and the wall surface W on which the AC power outlet is located is always in contact with the connecting surface 123 of the plug base 122 of the power adapter 10 and the round-shaped tangent of the enclosure 100. As a result, it is easier to fully insert the metal plug 121 of the power plug unit 120 into the AC power outlet.

In addition, even when a moment of rotation is exerted in a direction of one side (a left-right direction in a front view) by the USB cable 20, the power adapter 10 can be prevented from falling out due to the round shapes of the enclosure 100 coming into contact with the wall surface W.

Each of FIGS. 4A and 4B is a schematic explanatory diagram for describing a movement of the power adapter 10 according to the first embodiment when a force is applied to the power adapter 10 from the USB cable 20.

In FIGS. 4A and 4B, the power adapter 10 is inserted into an AC power outlet provided on the wall surface W that is inclined relative to a vertical direction.

First, let us suppose that a force F1 is applied to the USB port unit 130 by the USB cable 20 while neither the top surface 103 nor the rear surface 102 of the power adapter 10 in FIG. 4A is in contact with the wall surface W. In this case, since the radius r of the arc constituting the round shapes and a perpendicular distance L from the center of rotation of the plug base 122 to the connecting surface 123 with an opposite power outlet are the same length, a moment of rotation of the force F1 causes the power adapter 10 to rotate around the center of rotation of the plug base 122 and a state shown in FIG. 4B is created.

When the force F1 is further applied to the USB port unit 130 in the state shown in FIG. 4B, a moment of rotation due to the force F1 is applied to a fulcrum shown in the drawing and a force F2 is applied to the metal plug 121 of the power plug unit 120. When the force F2 is greater than a force of friction of the metal plug 121, the power adapter 10 is to fall out of the wall surface W.

If “a” denotes a distance between the fulcrum and the USB port unit 130 and “b” denotes a distance between the fulcrum and the metal plug 121, then the force F2 is expressed as F2=F1×a÷b, and since the fulcrum is on the top surface 103 of the power adapter 10, the shorter the distance between the top surface 103 and the USB port unit 130, the smaller the force F2.

Therefore, when compared to a conventional power adapter with the USB port unit 130 arranged on the bottom surface 104, when force is applied from the USB cable 20, the power adapter 10 according to the present embodiment creates an effect of making the power adapter 10 more unlikely to disconnect from the AC power outlet than the conventional power adapter.

In addition, in the power adapter 10 according to the present embodiment, the power plug unit 120 is rotatably fixed to the enclosure 100 at any angle. Therefore, when the force F1 is applied by the USB cable 20, due to the enclosure 100 (refer to FIG. 3) having been vertical being lifted by the force F1 (refer to FIGS. 4A and 4B), an effect is created in that rotations of the power plug unit 120 and the enclosure 100 absorb the moment of rotation exerted by the USB cable 20. In addition, a moment of rotation due to a center of gravity M of the enclosure 100 acts to counteract a moment of rotation exerted by the USB cable 20.

In this manner, even when a force is applied from the USB cable 20, the power adapter 10 according to the present invention creates an effect of making it unlikely for the power adapter 10 to disconnect from the AC power outlet because the connection of the metal plug 121 is maintained due to the rotation of the power plug unit 120.

### (Center of Gravity M)

FIG. 3 shows a position M of the center of gravity of the enclosure 100 of the power adapter 10. In the power adapter 10 according to the first embodiment, heavy components such as coils, capacitors, and power transistors are arranged in a vicinity of the power plug unit 120 and, further, the stepped part 110 is provided on the side of the bottom surface 104 so that the center of gravity M is on the side of the power plug unit 120 relative to the center of the enclosure 100.

In this case, the center of gravity M of the enclosure 100 is preferably provided on the side of the top surface than ½ and more preferably provided on the side of the top surface than ⅓ relative to an entire length in the longitudinal direction of the enclosure 100.

Accordingly, in the power adapter 10 according to the first embodiment, a distance between a fulcrum of a moment exerted by the center of gravity M and a point of effort is reduced, falling out due to vibrations or the like can be prevented, and the power adapter 10 can be made more unlikely to fall out of the AC power outlet even when installed at a location where there is vibration such as on a train or in a car.

### (First Modification)

Each of FIGS. 5A, 5B, 5C and 5D shows a first modification of the power adapter 10 according to the first embodiment.

FIG. 5A shows the stepped part 110 being provided in a part on a side of the bottom surface 104 of the front surface 101 when there is one USB port unit 130. In this case, a risk of the user catching the retaining portion can be more reliably reduced and damage to the USB cable 20 can be more reliably prevented.

FIG. 5B shows the stepped part 110 with two steps when there are four USB port units 130. In this case, four USB cables 20 can be readily inserted and extracted without interfering with each other.

While FIG. 5B shows an example in which left-right positions of upper-step and lower-step USB port units 130 are the same, the left-right positions of the USB port units 130 are not limited thereto and may be displaced between the upper-step and lower-step USB port units 130.

FIG. 5C shows a columnar portion of a same height as the front surface 101 being provided at center of the stepped part 110 in the left-right direction and the USB port unit 130 being arranged on the side surface 111 of the columnar portion. In this case, two USB cables 20 extend in opposite directions from each other, making the USB cables 20 less likely to interfere with each other and facilitating insertion and extraction of the USB cables 20.

FIG. 5D shows the stepped part 110 being provided in a part on a side of the bottom surface 104 of the front surface 101 in a similar manner to FIG. 5A and, further, the USB port unit 130 being arranged on the side surface 111 in the left-right direction of the stepped part 110. When the power adapter 10 is connected to an AC power outlet located near the floor in a room, the USB cable 20 can be conveniently extended in a horizontal direction.

### (Second Modification)

Each of FIGS. 6A and 6B shows a second modification of the power adapter 10 according to the first embodiment.

In FIG. 6A, a thickness (a distance between the front surface 101 and the rear surface 102) of the enclosure 100 is thick on the side of the top surface on which the power plug unit 120 is arranged and thin in the vicinity of the side surface 111 of the stepped part 110. In this case, since heavy components such as coils, capacitors, and power transistors can be arranged closer to the power plug unit 120, the center of gravity M of the power adapter 10 can be brought even closer to the power plug unit 120, and the power adapter 10 can be made more unlikely to fall out of the AC power outlet even when installed at a location where there is vibration such as on a train.

In FIG. 6B, a width (a distance between the right surface 105 and the left surface 106) of the enclosure 100 is wide on the side of the top surface on which the power plug unit 120 is arranged and narrow in the vicinity of the side surface 111 of the stepped part 110. Even in this case, since heavy components such as coils, capacitors, and power transistors can be arranged closer to the power plug unit 120, the center of gravity M of the power adapter 10 can be brought even closer to the power plug unit 120.

Note that the first modification and the second modification can be executed in an overlapping manner. In other words, the center of gravity M of the power adapter 10 can be brought even closer to the power plug unit 120 by increasing the thickness and increasing the width of the enclosure 100 on the side of the top surface 103 on which the power plug unit 120 is arranged.

### (Example of Use of Power Adapter 10)

Each of FIGS. 7A and 7B is a schematic explanatory diagram for describing a state of use of the power adapter 10 according to the first embodiment.

In recent years, the installation of AC power outlets for charging smartphones and the like has expanded. For example, in the Tokaido Shinkansen N700S, AC power outlets are installed in the armrests of all seats. However, in the case of the Shinkansen, the AC power outlets are located at the tip of the armrests and inclined obliquely downward due to constraints in location.

FIG. 7A shows an example of use when the power adapter 10 according to the present embodiment is connected to the AC power outlet of the armrest, and FIG. 7B shows an example of use when a conventional power adapter is connected.

In FIG. 7B, the power adapter protrudes diagonally forward from the AC power outlet at the tip of the armrest and the USB cable 20 extends from a tip of the power adapter. Therefore, there is a risk of the power adapter or the USB cable 20 touching the body of a passenger when the passenger is moving or the like and the power adapter falling off. In addition, since the USB cable 20 extends from the tip of the power adapter, a distance between the mounted portion of the USB cable 20 and the power plug is long, and when a force is applied to the USB cable 20, a moment of rotation with respect to the power plug increases and the power plug can readily fall out of the AC power outlet. Furthermore, since the center of gravity of a conventional power adapter is positioned horizontally separated from the AC power outlet, a large moment of rotation is readily generated due to train vibration and causes the power plug to readily fall out of the AC power outlet.

In contrast, when the power adapter 10 according to the present embodiment is connected to an AC power outlet at the tip of the armrest, the following effects are produced.

First, since the power plug unit 120 is rotatably fixed to the enclosure 100, as shown in FIG. 7A, the enclosure 100 can be rotated so that the power adapter 10 and the USB cable 20 are pointed downward and installation is facilitated even in a narrow space.

Next, since the power plug unit 120 is rotatably fixed to the enclosure 100, when a force is applied to the USB cable 20, a force applied to the power plug unit 120 can be reduced due to rotation of the enclosure 100.

Furthermore, since the USB port unit 130 is provided on the side surface 111 of the stepped part 110 and the distance between the power plug unit 120 and the USB port unit 130 is short, the moment of rotation with respect to the power plug unit 120 when a force is applied to the USB cable 20 further decreases, making it more unlikely for the power plug unit 120 to fall out of the AC power outlet.

In addition, since the retaining portion of the USB cable 20 is stored inside the stepped part 110, a risk of the user (passenger) catching the retaining portion can be reduced and damage to the USB cable 20 can be prevented.

Furthermore, in the power adapter 10 according to the present embodiment, since the center of gravity M is positioned close to the power plug unit 120 and the enclosure 100 becomes vertical due to a rotation of the power plug unit 120, the position of the center of gravity M is close to the AC power outlet in the horizontal direction. Accordingly, since the occurrence of a moment of rotation can be suppressed, the power plug unit can be prevented from falling out of the AC power outlet even when a train vibrates.

As described above, compared to the conventional power adapter shown in FIG. 7B, the power adapter 10 according to the present embodiment shown in FIG. 7A produces the effects of preventing the USB cable 20 from getting in the way when the passenger moves and making it unlikely for the power adapter 10 to fall out from the AC power outlet even when a force is applied to the USB cable 20.

### Second Embodiment

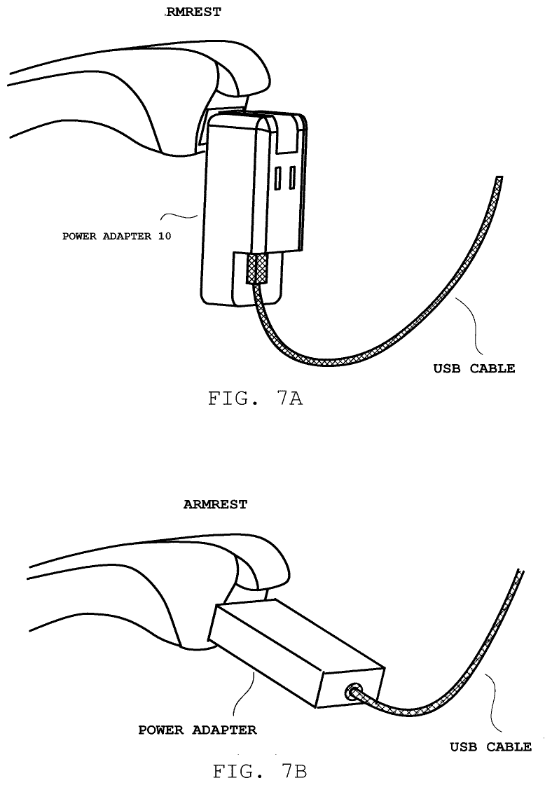

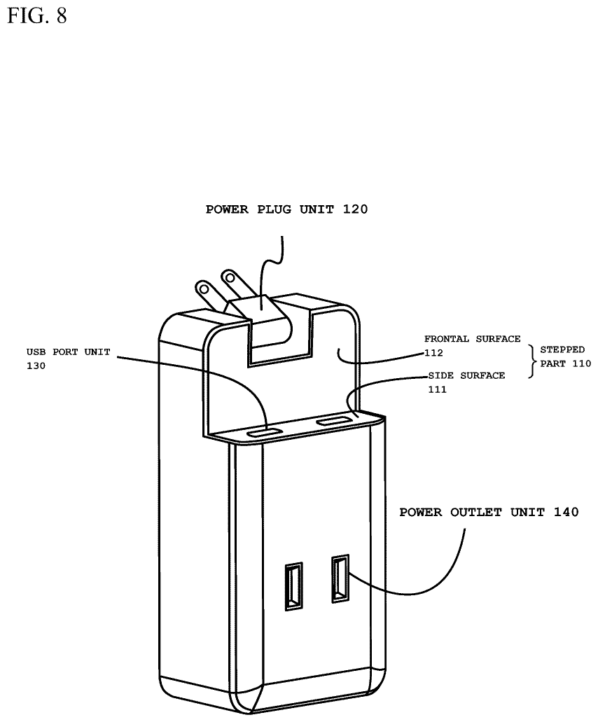

FIG. 8 is a schematic perspective view of the power adapter 10 according to a second embodiment.

In the power adapter 10 according to the second embodiment, the stepped part 110 is provided on a side of the top surface 103 of the front surface 101 and is constructed in a staircase shape by the side surface 111 that is substantially orthogonal to the front surface 101 and the frontal surface 112 that is parallel to the front surface 101 and closer to the rear surface 102. In other words, the stepped part 110 is provided in a vicinity of the power plug unit 120. The configuration is otherwise the same as in the power adapter 10 according to the first embodiment.

In this case, since the distance between the USB port unit 130 and the power plug unit 120 is small and a magnitude of a moment of rotation with respect to the power plug unit 120 decreases when a moment of rotation is exerted to the USB port unit 130 from the USB cable 20, similar effects to the first embodiment are produced such as making it unlikely for the power adapter 10 to fall out from the AC power outlet.

In the present invention, the power plug unit 120 corresponds to the “power plug unit”, the USB port unit 130 corresponds to the “USB port unit”, the power outlet unit 140 corresponds to the “power outlet unit”, the enclosure 100 corresponds to the “enclosure”, the front surface 101 corresponds to the “front surface”, the rear surface 102 corresponds to the “rear surface”, the top surface 103 corresponds to the “top surface”, the bottom surface 104 corresponds to the “bottom surface”, the right surface 105 corresponds to the “right surface”, the left surface 106 corresponds to the “left surface”, the power adapter 10 corresponds to the “power adapter”, the stepped part 110 corresponds to the “stepped part”, the side surface 111 corresponds to the “side surface”, the frontal surface 112 corresponds to the “frontal surface”, the metal plug 121 corresponds to the “metal plug”, the plug base 122 corresponds to the “plug base”, the connecting surface 123 corresponds to the “connecting surface”, and the storage unit 124 corresponds to the “storage unit”.

While preferable embodiments of the present invention are as described above, the present invention is not limited thereto. It should be understood that various other embodiments may be made without deviating from the spirit and the scope of the present invention. Furthermore, while operations and effects due to the configuration of the present invention have been described in the present embodiment, the operations and effects are merely examples and are not intended to limit the present invention.

### REFERENCE SIGNS LIST

10 power adapter
100 enclosure
101 front surface
102 rear surface
103 top surface
104 bottom surface
105 right surface
106 left surface
110 stepped part
111 side surface
112 frontal surface
120 power plug unit
121 metal plug
122 plug base
123 connecting surface
124 storage unit
130 USB port unit
140 power outlet unit
M center of gravity

1. A power adapter, comprising:
a power plug unit that can be inserted into an AC power outlet, a USB port unit that can feed power to a USB device, and a substantially rectangular parallelepiped-shaped enclosure having a front surface, a rear surface, a top surface, a bottom surface, a right surface, and a left surface, wherein
the power plug unit is provided on a side of the top surface of the rear surface of the enclosure and is rotatably fixed to the enclosure at any angle,
the enclosure is provided with a stepped part on the side of the top surface or a side of the bottom surface of the front surface, and
the USB port unit is provided on a side surface that is substantially orthogonal to the front surface of the stepped part.

2. The power adapter according to claim 1, wherein the stepped part is provided on the side of the bottom surface of the front surface and constructed in a staircase shape with a side surface that is substantially orthogonal to the front surface and a frontal surface that is parallel to the front surface and closer to the rear surface.

3. The power adapter according to claim 1, wherein the stepped part is provided on the side of the top surface of the front surface and constructed in a staircase shape with a side surface that is substantially orthogonal to the front surface and a frontal surface that is parallel to the front surface and closer to the rear surface.

4. The power adapter according to claim 1, further comprising
a power outlet unit capable of feeding AC power to another device, wherein
the power outlet unit is provided on the front surface of the enclosure.

5. The power adapter according to claim 1, wherein the power adapter is configured such that a center of gravity of the power adapter is on a side of the power plug unit relative to a center of the enclosure.

6. The power adapter according to claim 1, wherein a length N in a longitudinal direction of the enclosure in the stepped part is 1.5 cm or more.

7. The power adapter according to claim 1, wherein
the enclosure includes a storage unit that can accommodate the power plug unit,
the power plug unit is axially supported so as to be parallel to an intersecting side of the top surface and the rear surface and is rotatably fixed to the enclosure at any angle, and
a range of angles in which the power plug unit can rotate is more than 90° and equal to or less than 180°.

8. The power adapter according to claim 7, wherein
corners of the right surface and the left surface of the enclosure that axially support the power plug unit each has a round-shaped cross section,
the power plug unit includes a metal plug and a plug base that supports the metal plug,
and a center of an arc constituting the round shape and a center of rotation of the plug base coincide with each other, and a radius r of the arc constituting the round shape and a perpendicular distance L from the center of rotation of the plug base to a connecting surface with an opposite power outlet are a same length.
